(19) United States
(12) Patent Application Publication
(10) Pub. No.: US 2002/0182361 A1
(43) Pub. Date: Dec. 5, 2002

(54) Sweeping board and laminated wood

(76) Inventor: Mitsuru Hayakawa, Nagano (JP)

Correspondence Address: BURNS DOANE SWECKER & MATHIS L L P, POST OFFICE BOX 1404, ALEXANDRIA, VA, 22313-1404, US

(21) Appl. No.: 10/089,679

(22) PCT Filed: Jul. 31, 2001
(86) PCT No.: PCT/JP01/06611

(30) Foreign Application Priority Data
Aug. 10, 2000 (JP) 2000-242222

(51) Int. Cl. B32B 3/00

(52) U.S. Cl. 428/60; 428/58

(57) ABSTRACT

A laminated pillar (1) is composed of five lumber-boards (4) laminated and bonded together in the thickness direction. Each lumber-board 4 has a first board portion (5) that is the portion positioned at the ground end, formed of a first type of wood such as Japanese cedar or the like that has excellent resistance to corrosion, dirt, and ants, and a second board portion (6) formed of a second type of wood that is cheap, such as whitewood or the like. These board portions (5), (6) are bonded together in the axial direction by means of finger joints (7). In the laminated pillar (1) comprised by a bonded lamination of the lumber-boards 4 thus configured, the portion at the ground end is first laminated lumber portion (2) formed of the first type of wood, and therefore does not require corrosion-proofing/ant-proofing treatment. Therefore, structural laminated lumber can be realized that is low-priced and facilitates on-site work.

### BACKGROUND OF THE INVENTION

1. Technical Field

The present invention relates to laminated lumber suited for use mainly for pillars, studs, braces and the like in wooden houses and the like, and to lumber-board constituting the laminated lumber.

2. Prior Art

In wooden houses and other wooden structures, extensive use is made of structural laminated lumber and laminated lumber for fittings. Generally, such laminated lumber comprises wooden boards (lumber-board) of from about 2 to 5 cm thick that are laminated together with the grain parallel with the length direction, and bonded together with synthetic resin adhesive to unite them as a material. Compared to cases in which solid wood is used to make pillars and the like, this has the advantage of making it possible to produce defect-free pillars and the like at low cost and in large quantities.

When the laminated lumber concerned is used as structural material or the like for wooden houses, for example, from the standpoint of resistance to corrosion and dirt, and resistance to ants, types of woods such as Japanese cypress, Japanese cedar, American cypress, American cedar, umbrella pine, chestnut, zelkova and the like are used for the laminated lumber. Also, when laminated lumber is used that is comprised of wood having poorer durability than those types of woods, it is subjected to anticorrosion and anti-ant treatment using pharmaceutical agents. The anti-corrosion and anti-ant treatment concerned is normally done at the factory. Also, pharmaceutical agents are applied to parts of the laminated lumber that are processed, cut or bored on-site.

Compared to other woods, woods such as Japanese cypress and Japanese cedar and the like that have resistance to corrosion, dirt and ants are normally more expensive and are also difficult to obtain in large quantities. Because of this, with respect to the manufacture of pillars and braces comprised of laminated lumber using wood having such durability, the advantage of being cheaper than solid wood is lost.

Also, in cases where pillars and braces are manufactured using laminated lumber comprised of cheap woods that have poor durability, anti-corrosion and anti-ant treatment has to be carried out. The processing work is therefore increased by that amount, which is an impediment to reducing the manufacturing cost. Moreover, on-site work is complicated by the need for the on-site task of applying pharmaceutical agents to parts that are processed, cut or bored on-site.

In view of such points, the task of the present invention is to propose lumber-board that can be manufactured at a low price and does not require anti-corrosion and anti-ant treatment, and laminated lumber comprised of bonded laminations of the lumber-board.

### SUMMARY OF THE INVENTION

To resolve the above problems, the present invention provides a lumber-board having a first board portion of a first type of wood and a second board portion of a second type of wood,

the first and second board portions having identical cross-sections and the end faces thereof being bonded together to form one board,

characterized in that a resistance to corrosion and dirt and a resistance to ants of the first type of wood are higher than those of the second type of wood.

Here, the first type of wood can be any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

The joints of the first and second board portions can be finger joints, scarf joints or butt joints.

Generally, the length of the first board portion in the direction of the board axis should be at least 1 meter.

Next, a plurality of board portions bonded together along their axial direction can be used to constitute the first board portion. In the same way, a plurality of board portions bonded together along their axial direction can be used to constitute the second board portion.

The lumber-board of the present invention can be used as studs and braces for constructing wooden houses.

The structural laminated lumber of the invention formed by a plurality of lumber-board laminations bonded in the thickness direction,

in which the lumber-board has a first board portion of a first type of wood and a second board portion of a second type of wood,

the first and second board portions having identical cross-sections and the end faces thereof being bonded together to form one board,

characterized in that a resistance to corrosion and dirt and a resistance to ants of the first type of wood are higher than those of the second type of wood.

Here, the first type of wood can be any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

The joints of the first and second board portions can be finger joints, scarf joints or butt joints.

Generally, the length of the first board portion in the direction of the board axis should be at least 1 meter.

Here, a plurality of board portions bonded together along their axial direction can be used to constitute the first board portion. In the same way, a plurality of board portions bonded together along their axial direction can be used to constitute the second board portion.

The laminated lumber according to the present invention can be used for pillars, studs, and braces for constructing wooden houses.

### BRIEF DESCRIPTION OF THE DRAWINGS

FIGS. 1(a) and (b) area perspective view of an example of a laminated pillar comprised using the lumber-board of the present invention, and a perspective view of the five constituent lumber-boards thereof.

FIGS. 2(a) and (b) are a perspective view of an example of a laminated pillar comprised using the lumber-board of the present invention, and a perspective view of the three constituent lumber-boards thereof.

FIG. 3 is a perspective view of an example of a laminated pillar with 3-ply structure using the lumber-board of the present invention.

FIG. 4 is a perspective view of an example of a laminated stud according to the present invention.

Explanation of Symbols

1, 11 Laminated pillars

21 Laminated stud

1a End face

2, 12, 22 First laminated lumber portions

3, 13, 23 Second laminated lumber portions

4 Lumber-board

5, 15 First board portions

6, 16 Second board portions

7, 8, 9, 17, 27 Finger joints

### BEST MODE FOR CARRYING OUT THE INVENTION

Examples of structural laminated lumber that apply the present invention are explained below, with reference to the drawings.

### EXAMPLE 1

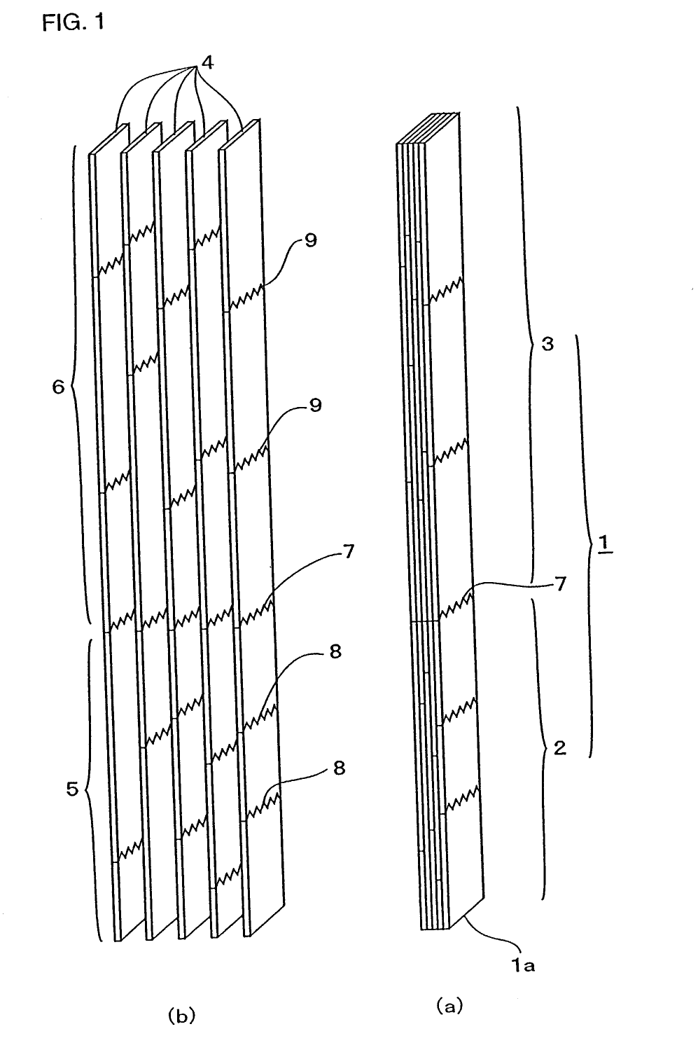

FIG. 1 is a drawing showing an example of a laminated pillar that applies the present invention. In this example, the laminated pillar 1 comprises a first laminated lumber portion 2 that is the portion set at the ground end, formed of a first type of wood that has high durability such as Japanese cedar or the like, while other parts are constituted by a second laminated lumber portion 3, formed of a second type of wood that is cheap, such as whitewood or the like. The first type of wood can be any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

According to the specifications of Japan's Housing Loan Corporation, the first laminated lumber portion 2 should be formed of a type of wood specified as durable, while the second laminated lumber portion 3 can be formed of a non-specified type of wood, and the first laminated lumber portion 2 should be at least 1 meter long, from the end face 1a.

The laminated pillar 1 is a 5-ply structure composed of a lamination of five lumber-boards 4 bonded together using synthetic resin adhesive. The lumber-boards 4 each include a first board portion 5 of a first type of wood and a second board portion 6 of a second type of wood. The board portions 5, 6 have the same flattened rectangular cross-sectional. Also, the end faces of the first and second board portions 5, 6 are joined together by finger joints 7.

Moreover, in this example, the first board portion 5 is structured as two or more board portions bonded together in the axial direction by finger joints 8. The finger joints 8 of adjacent board portions 5 are located at different positions along the direction of the axis. Similarly, the second board portion 6 is structured as two or more board portions bonded together in the axial direction by finger joints 9. In this case too, the finger joints 9 of adjacent second board portions 6 are set to be at different positions along the direction of the axis.

Laminated pillars 1 thus configured are usually in the order of 105 mm square, 135 mm square, and in length, in the order of from 2800 mm to 6000 mm. The first laminated lumber portion 2 formed of the first board portion 5 is in the order of 500 to 1000 mm long.

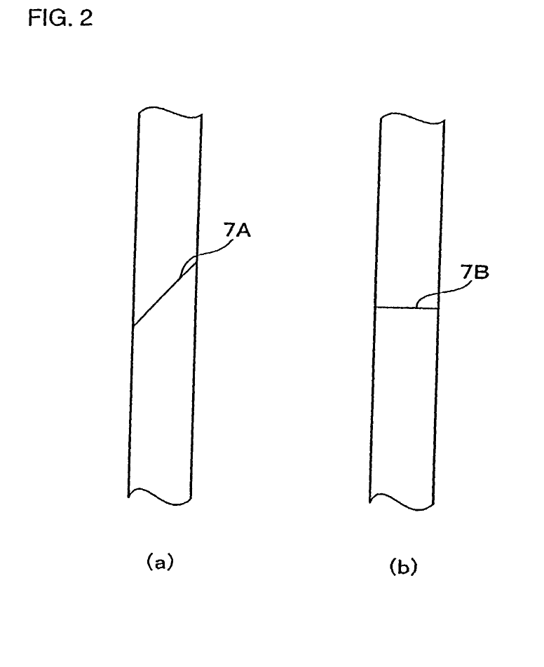

Instead of the finger joint 7, the first and second board portions 5, 6 can use the scarf joint 7A shown in FIG. 2(a), or the butt joint 7B shown in FIG. 2(b). Similarly, a scarf joint or butt joint can be used instead of the finger joints 8, 9 in each of the lumber-boards 4.

### EXAMPLE 2

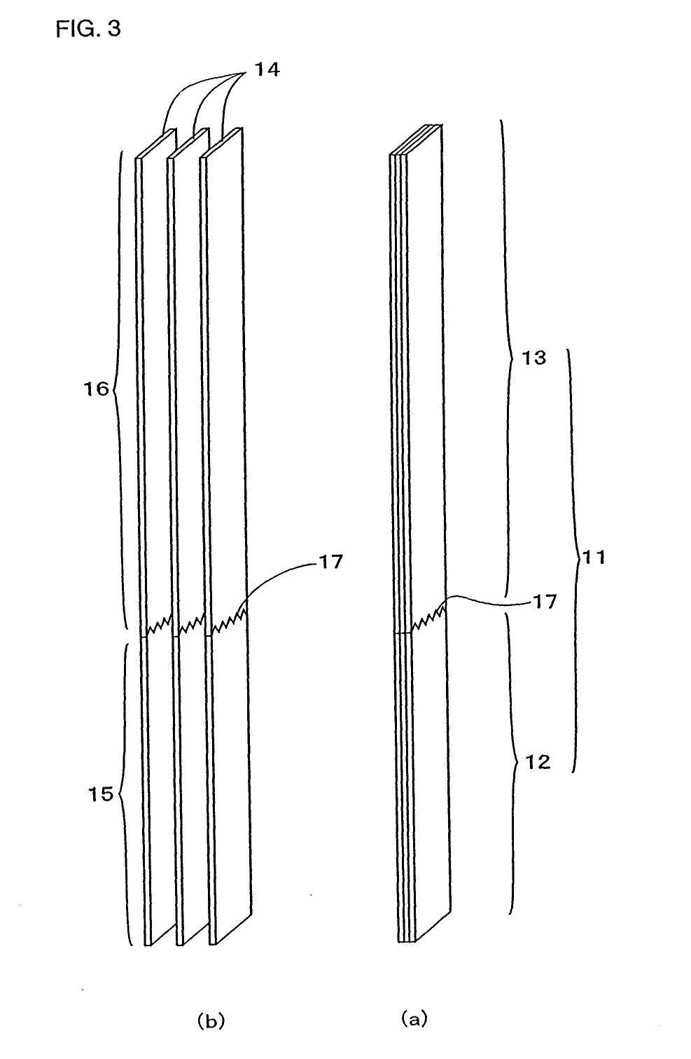

FIG. 3 shows an example of a laminated pillar with 3-ply structure. This laminated pillar 11 has a similar structure to the laminated pillar 1 of FIG. 1. That is, the laminated pillar 11 comprises a first laminated lumber portion 12 that is the portion set at the ground end, formed of a first type of wood that has high durability such as Japanese cedar or the like, while other parts are constituted by a second laminated lumber portion 13, formed of a second type of wood that is cheap, such as whitewood or the like.

Here, the laminated pillar 11 of this example is structured as three lumber-boards 14 laminated and bonded together in the thickness direction. Each of the lumber-boards 14 has a first board portion 15 of a first type of wood, and a second board portion 16 of a second type of wood; these first and second board portions 15, 16 have the same cross-section, and are bonded to form one board by means of finger joints 17 on their end faces.

Here, the resistance to corrosion and dirt, and the resistance to ants, of the first type of wood are higher than those of the second type of wood. The first type of wood is, for example, any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

Instead of the finger joint 17, the first and second board portions 15, 16 can use a scarf joint or butt joint.

In this example, the first and second board portions 15, 16 are formed of single boards but, as in the case of example 1, can be formed of a plurality of boards joined together in the axial direction.

In the laminated pillar 11 of this example too, the length of the first board portion 15 in the direction of the board axis should be at least in the order of 1000 mm.

### EXAMPLE 3

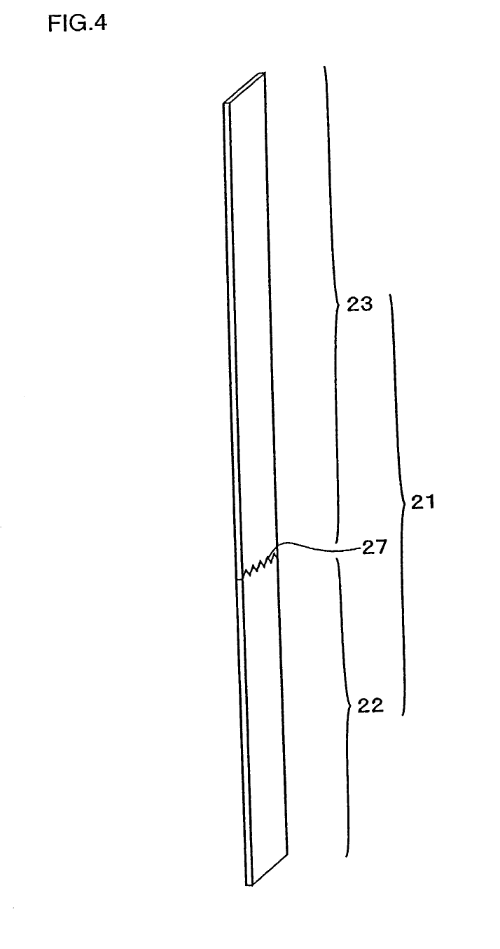

FIG. 4 shows an example of a laminated stud according to the present invention. The laminated stud 21 is formed from a single lumber-board, and comprises a first board portion 22 that is the portion set at the ground end, formed of a first type of wood that has high durability such as Japanese cedar or the like, while the other part is constituted by a second board portion 23, formed of a second type of wood that is cheap, such as whitewood or the like; these parts are bonded together by finger joints 27.

According to the specifications of Japan's Housing Loan Corporation, the first board portion 22 should be at least 1000 mm long.

The laminated stud 21 thus configured is, for example, 27 mm, 30 mm, 45 mm thick, 105 mm, 120 mm wide, and 2800 mm long.

Here, as the first type of wood, there can be used any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

Instead of the finger joint 27, the first and second board portions 22, 23 can use a scarf joint or the butt joint.

In this example too, the first and second board portions 22, 23 are formed of single boards but, as in the case of example 1, can be formed of a plurality of boards joined together in the axial direction. And, the laminated stud can be composed of a bonded lamination of a plurality of lumber-boards.

### OTHER EXAMPLES

In addition to structural pillars and studs, the laminated lumber according to this invention can be utilized for braces and other members.

Also, the length of the first laminated lumber portion (first board portion) is not limited to the 1000 mm in the above examples, but can be changed to suit the application.

Industrial Applicability

As described in the foregoing, the lumber-board of this invention comprises a first board portion formed of a first type of wood that has high resistance to corrosion, dirt and ants, and a second board portion formed of a cheap, second type of wood that are bonded together in the axial direction of the boards by means of an adhesive. The laminated lumber of this invention is comprised of one lumber-board, or a plurality of lumber-board laminations bonded in the thickness direction.

Therefore, by using the laminated lumber of this invention in which different types of wood are joined together, low-priced pillars, studs and the like can be provided for wooden housing that do not need the part set at the ground end to be treated for protection against corrosion and ants.

It also becomes possible to provide low-priced pillars and studs and the like for wooden housing, which does not require anti-corrosion and anti-ant treatment to be done at the construction site.

1. Lumber-board having a first board portion of a first type of wood and a second board portion of a second type of wood,
the first and second board portions having identical cross-sections and the end faces thereof being bonded together to form one board,
characterized in that a resistance to corrosion and dirt and a resistance to ants of the first type of wood are higher than those of the second type of wood.

2. In claim 1,
lumber-board characterized by the first type of wood being any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

3. In claim 2,
lumber-board characterized by the joints of the first and second board portions being finger joints, scarf joints or butt joints.

4. In claim 3,
lumber-board characterized by a length of the first board portion in the direction of the board axis being at least 1 meter.

5. In claim 4,
lumber-board characterized by the first board portion comprising a plurality of board portions bonded together along their axial direction.

6. In claim 4,
lumber-board characterized by the second board portion comprising a plurality of board portions bonded together along their axial direction.

7. A stud comprised of lumber-board according to any of claims 1 to 6.

8. A brace comprised of lumber-board according to any of claims 1 to 6.

9. Structural laminated lumber formed by a plurality of lumber-board laminations bonded in a thickness direction,
in which the lumber-board has a first board portion of a first type of wood and a second board portion of a second type of wood,
the first and second board portions having identical cross-sections and the end faces thereof being bonded together to form one board,
characterized in that a resistance to corrosion and dirt and a resistance to ants of the first type of wood are higher than those of the second type of wood.

10. In claim 9,
structural laminated lumber characterized by the first type of wood being any one from among Japanese cedar, American cedar, Japanese cypress, American cypress, Australian cypress, Japanese red pine, larch, American pine, Russian larch, American hemlock, cedar heart wood, spruce, umbrella pine, chestnut, and zelkova.

11. In claim 10,
structural laminated lumber characterized by the joints of the first and second board portions being finger joints, scarf joints or butt joints.

12. In claim 11,
structural laminated lumber characterized by a length of the first board portion in the direction of the board axis being at least 1 meter.

13. In claim 12,
structural laminated lumber characterized by the first board portion comprising a plurality of board portions bonded together along their axial direction.

14. In claim 12,
structural laminated lumber characterized by the second board portion comprising a plurality of board portions bonded together along their axial direction.

15. A pillar comprised of structural laminated lumber according to any of claims 8 to 11.

16. A brace comprised of structural laminated lumber according to any of claims 9 to 12.

17. A brace comprised of structural laminated lumber according to any of claims 9 to 12.
